(19) United States
(12) Patent Application Publication
(10) Pub. No.: US 2025/0356643 A1
(43) Pub. Date: Nov. 20, 2025

(54) METHOD AND SYSTEM FOR TRAINING AND DEPLOYMENT OF AI NEURAL NETWORK IN HUMAN ACTION SKILLS BASED EXAMINATIONS

(71) Applicant: EXAMROOM.AI CORP., LAKE MARY, FL (US)

(72) Inventors: VINOD KUMAR JAYAKEERTHI, Sorrento, FL (US); PHILIP DUWAYNE DICKISON, Clearwater Beach, FL (US); HENRY LUND SORENSEN, Sandy, UT (US); BHARATH VIRUPAKSHAPPA SAGAR, Shimoga (IN); DEEPAK MADHUKAR KOLEKAR, Bengaluru (IN); ADARSH SINGH DIKHIT, Satna (IN)

(21) Appl. No.: 18/971,220

(22) Filed: Dec. 6, 2024

Related U.S. Application Data
(60) Provisional application No. 63/648,871, filed on May 17, 2024.

(51) Int. Cl. G06V 10/82; G06V 10/776; G06V 20/40

(52) U.S. Cl. CPC G06V 10/82; G06V 10/776; G06V 20/41

(57) ABSTRACT

A method and system of training and deploying an artificial intelligence (AI) neural network for skills based examinations. A method of training the AI neural network includes providing, via input layers of the AI neural network, a training dataset of human action images for skills based examinations that require human actions performed in accordance with a predetermined sequence, generating, at an output layer of the AI neural network, a correlation between the training dataset and a validation dataset of human action images for the skills-based examination, the input layers and the output layer being interconnected via a set of fully connected layers of the AI neural network, and validating the AI neural network based on a training loss function expressed in accordance with the correlation between the training dataset and the validation dataset.

### RELATED APPLICATIONS

This application claims the benefit of priority to U.S. Provisional Patent Application No. 63/648,871 filed on May 17, 2024. Said U.S. Provisional Patent Application No. 63/648,871 is hereby incorporated in its entirety.

### TECHNICAL FIELD

Disclosures herein relate to distributed computer network systems for examination testing contexts including training of artificial intelligence (AI) neural networks for deployment therein.

### BACKGROUND

The introduction and increasing prevalence of online examinations has necessitated a requirement for secure, reliable and efficient technologies that facilitate a seamless testing experience while maintaining integrity of examination ecosystems, including related examination proctoring solutions. Skills-based (“skills based” as referred to herein) examination testing may implicate and even mandate, among other aspects, performance of human actions by an examination candidate.

From a practical standpoint, it can be challenging for proctoring systems, especially in context of remotely located candidates, to accurately, consistently and objectively evaluate candidates during skills based examination testing that requires, among other aspects, performance of human actions. Furthermore, to the extent that attempts to circumvent mandated procedures and standards for the skills based examination may arise and even partially succeed, integrity of the examinations and consequentially, public confidence in professionals and attendant professional standards related thereto, are placed at risk of compromise.

### DESCRIPTION OF THE DRAWINGS

Whereas novel aspects believed characteristic of the invention are set forth in the appended claims, embodiments described herein will be understood by those of skill in the art with reference to the following detailed description and accompanying drawing figures in which like reference numerals indicate similar or identical features and components.

FIG. 1 shows, in an example embodiment, a distributed computer network system for training and deployment of an AI neural network in a skills based examination system.

FIG. 2 shows, in an example embodiment, an architecture of a computer system for training and deployment of an AI neural network in a skills based examination system.

FIG. 3 shows, in an example embodiment, a process for training an AI neural network in in a skills based examination system.

FIG. 4 shows, in an example embodiment, a scheme for validating an AI neural network based on a training loss function expressed in accordance with a correlation between a training dataset and a validation dataset.

FIG. 5 shows, in an example embodiment, a scheme for validating an AI neural network based on an accuracy function expressed in accordance with a correlation between a training dataset and a validation dataset.

FIG. 6 shows, in an example embodiment, a process for deploying an AI neural network in a skills based examination system.

### DETAILED DESCRIPTION

Embodiments herein recognize challenges in proctoring and administering skills based examinations, offline, online, and for remotely located examination candidates while maintaining integrity and quality standards of the examination process without undue risk of compromise. Among other advantages and benefits, techniques are provided for training an AI neural network which can then be deployed in secure, efficient and failsafe proctoring and administering of skills based examinations.

As referred to herein, a skills based test (also referred to herein as a skills based examination) includes or constitutes a practical test that can be used to assess a candidate's ability to perform a plurality of human actions, such as hair cutting, hair dyeing, beard trimming, hair curling, etc., in a universally agreed upon or acceptable sequence. A human action as referred to herein can be defined as a motion or a plurality of motions, whether performed sequentially or at least partly overlapping, by a person or several people. Learning to detect and distinguish between different and complex human actions is essential in proctoring and in evaluating a candidate's performance of the skills based test. Skills based tests are widely used by institutions to assess the suitability of a candidate to perform job related activities ranging from vocational skills to complex professional procedures. The increasing prevalence of online education systems has presented new challenges for skills based testing, especially where candidates may opt to take tests at times and geo-locations of their convenience. However, institutions find it challenging to monitor candidates individually and separately, given the scale and amount of manpower that would be required to proctor each candidate. Techniques and systems for training and deploying AI neural network solutions, as presented herein provide, among other benefits and advantages, an efficient proctoring system for detecting human actions, whether sequentially or at least partly overlapping, as performed by a skills based examination candidate.

Provided is a method of training an AI neural network in validating a set of human actions performed in a skills based examination. The method comprises providing, via one or more input layers of the AI neural network, a training dataset of human action images associated with the skills based examination, the skills based examination mandating ones of the set of human actions performed in accordance with a predetermined sequence; generating, at an output layer of the AI neural network, a correlation between the training dataset and a validation dataset of human action images associated with the skills-based examination, the one or more input layers and the output layer being interconnected in accordance with a set of fully connected layers of the AI neural network; and validating the AI neural network based on at least one of a training loss function and an accuracy function expressed in accordance with the correlation between the training dataset and the validation dataset.

Also provided is a method of deploying a trained AI neural network in a skills based examination session. The method comprises receiving, at a proctor computing system, a set of timestamped images transmitted from a candidate computing device, the set of timestamped images encoding data regarding durations associated with respective ones of a set of human actions as performed by an examination candidate in the skills based examination session; and generating, in association with the AI neural network, a candidate performance profile based at least in part on the set of timestamped images.

Further provided is an examination proctor computer system comprising one or more processors and a memory storing instructions executable in the one or more processors. The instructions encode a trained AI neural network that is instantiated in the one or more processors, the instructions further causing the one or more processors to implement operations comprising receiving, from a candidate computing device that is interconnected with the examination proctor computing system within a distributed network computing system, a set of timestamped images transmitted from the candidate computing device, the set of timestamped images associated with performance of a skills based examination performed by an examination candidate; and generating, in association with the trained AI neural network, a candidate performance profile based at least in part on the set of timestamped images. In some embodiments, the examination proctor computing system further comprises executable instructions for assigning, to the examination candidate, an examination performance result based at least in part upon the candidate performance profile.

Also provided is a computer-readable non-transitory memory having instructions stored thereon. The instructions are executable to cause one or more processors to implement operations including receiving, from a candidate computing device that is interconnected with an examination proctor computing system within a distributed network computing system, a set of timestamped images transmitted from the candidate computing device, the set of timestamped images associated with performance of a skills based examination performed by an examination candidate; and generating, in association with a trained AI neural network, a candidate performance profile based at least in part on the set of timestamped images. In some embodiments, the instructions when executed in one or more processors further cause the one or more processors to implement operations comprising assigning, to the examination candidate, an examination performance result based at least in part upon the candidate performance profile.

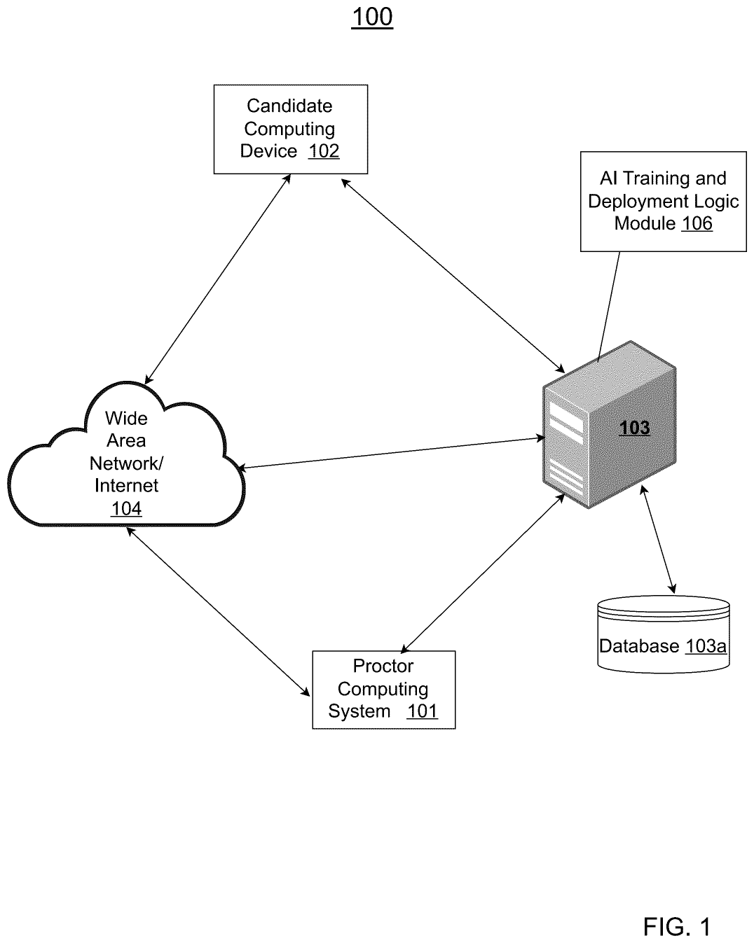

FIG. 1 shows, in an example embodiment, a distributed computer network system that incorporates training and deployment of an AI neural network 100 in a skills based examination system. In embodiments, AI neural network 100 includes AI training and deployment logic module 106 of server computing system 103 is based on processor-executable instructions stored in a memory of server 103, or proctor computing system 101, then instantiated via execution of the processor-executable instructions as stored. Server computing system 103 may be interconnected with database 103a, or in some embodiments, incorporate database 103a. It is contemplated that the instructions executable to instantiate the AI neural network may be stored in portions or components across server computing system 103 in conjunction with proctor computing system 101, implemented in parts or in whole across one or both of server computing system 103 in conjunction with proctor computing system 101 in combination, in some variations. Server computing system 103 and proctor computing system 101 may be interconnected directly, or via a local area network or wide area network 104, in some embodiments. In this manner, the AI neural network may be instantiated by processor devices and memory in any one of server computing system 103 and proctor computing system 101 or across both server computing system 103 and proctor computing system 101 working cooperatively, as will be apparent to those of skill in the art of distributed computer networking systems and cloud computing systems.

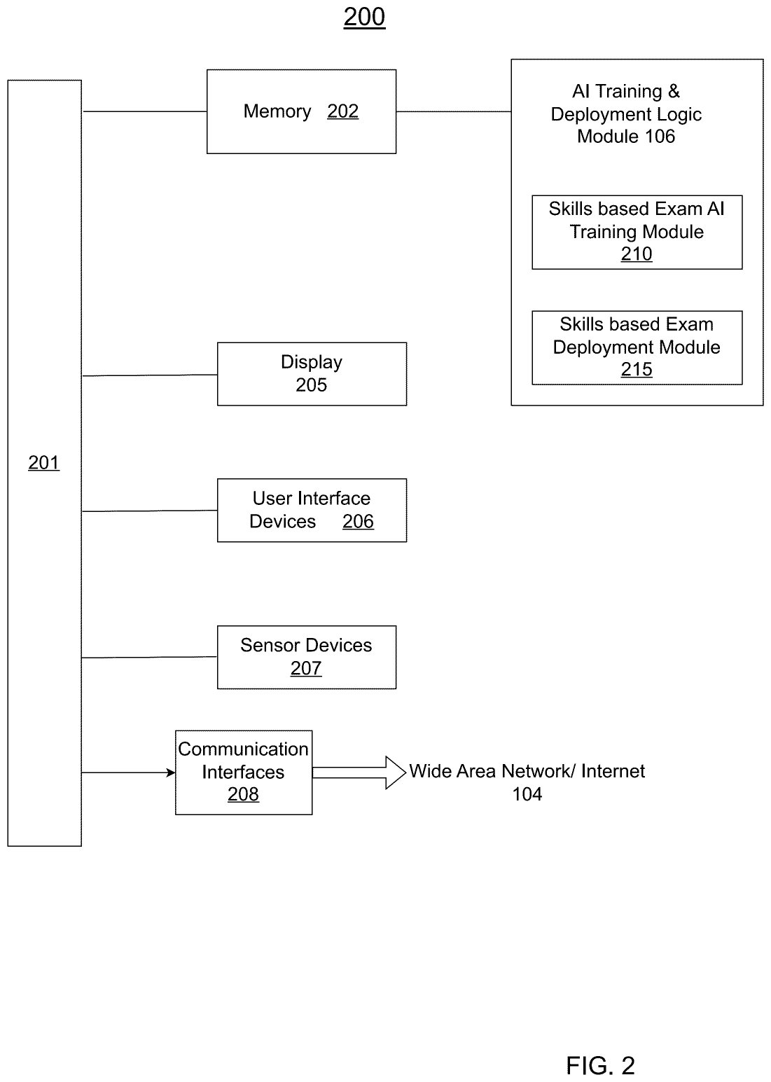

FIG. 2 shows, in an example embodiment, an architecture 200 of a computer system for training and deployment of an AI neural network in a skills based examination system. The example embodiment of architecture 200 will next be described with reference to server computing system 103. However, it is contemplated that, as will be appreciated by ones of skill in the art of distributed computing networks, at least some portions of logic componentry and functionality ascribed to server computing system 103 may be incorporated into proctor computing system 101, or similar interconnected computing systems, in alternate or additional embodiments. For instance, it is contemplated that at least some of the functionality of AI training and deployment logic module 106, including skills based examination module 210 and skills based examination deployment module 215 may be implemented or incorporated variously, including in portions or an entirety, across server computing system 103 in conjunction with proctor computing system 101.

AI training and deployment logic module 106, constituted of skills based examination module 210 and skills based examination deployment module 215, may be implemented using programmable instructions stored in memory 202, and being executable in one or more processor devices, including such as processor 201. Memory 202 may include, though not necessarily be limited to, non-volatile memory device(s), including dynamic random access memory (DRAM) or static random access memory (SRAM) non-transitory memory storage media or devices, and any combinations thereof. Although functionality ascribed to AI training and deployment logic module 106 is described herein, for sake of providing clarity to ones of ordinary skill in the art, in context of discrete logic modules, skills based examination module 210 and skills based examination deployment module 215, it is contemplated that functionality ascribed to AI training and deployment logic module 106 herein should not be limited in implementation to literal discrete logic modules as skills based examination module 210 and skills based examination deployment module 215 used to describe example embodiments herein. For instance, in alternate or additional embodiments, certain aspects of functionality ascribed to those discrete modules may be incorporated or subsumed, at least in portions, variously across others of those discrete logic modules.

In some variations, at least some portions of functionality of AI training and deployment logic module 106 including its constituent logic modules, specifically skills based examination module 210 and skills based examination deployment module 215 may be implemented in accordance with hard-wired circuitry and electronic componentry. The hard-wired circuitry and electronic componentry may be, without limitation, such as field programmable gate array (FPGA) devices and similar hard-wired electronic circuitry and componentry device implementations.

Skills based examination module 210 includes logic instructions for implementing functionality that includes generating a training dataset of human action images associated with the skills based examination. The skills based examination may mandate the set of human actions, and sequence or sequences, including durations for the human actions and combinations thereof.

The functionality may include generating, at an output layer of the AI neural network 100, a correlation between the training dataset and a validation dataset of human action images associated with the skills-based examination. The input layers and the output layer are interconnected, in some embodiments, in accordance with a set of fully connected layers of the AI neural network 100.

Validating the AI neural network, in some embodiments, may be based on one or more of a training loss function and an accuracy function expressed in accordance with the correlation between the training dataset and the validation dataset.

In some aspects, the skills based examination mandates performance by an examination candidate in accordance with respective ranges of predetermined durations in accordance with the predetermined sequence.

In embodiments, creating the training dataset may be based on pre-processing a plurality of human action videos. The pre-processing may include extraction of video frames based on one or more of predetermined time intervals and human action motion detections, wherein temporal dynamics of the human action motions that are constituted in the human action videos can be captured. In some aspects, the AI neural network may be based on a fusion of a convolutional neural network (CNN) and a long short term memory (LSTM) neural network. In such fusion, or hybrid, arrangement, the CNN performs spatial feature extraction and the LSTM neural network captures temporal dependencies. The fusion architecture may incorporate features of sequentially feeding the output of the CNN as input into the LSTM network, thereby enabling the AI neural network to contemporaneously learn spatial and temporal features of the human action motions performed.

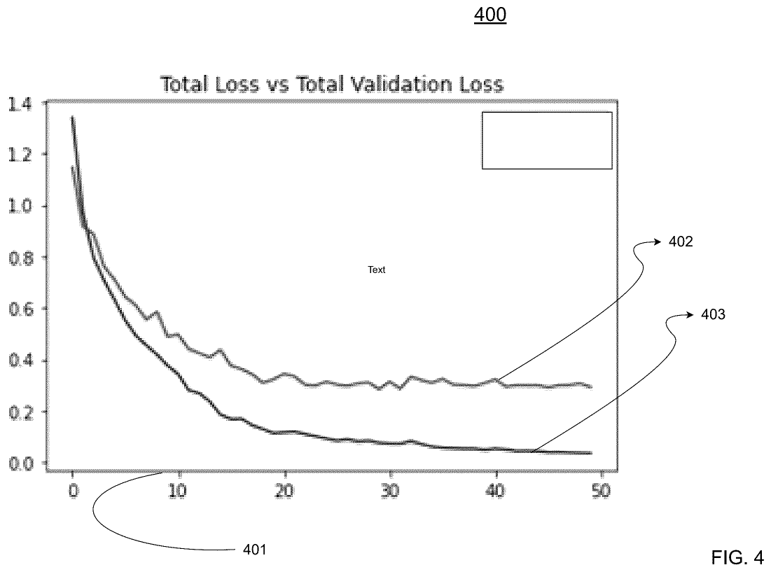

The training loss function, in some embodiments, may comprise a total training loss and a total validation loss over a given number of training epochs. In the example of FIG. 4, for instance, 50 training epochs were applied, measuring total training loss and total validation loss.

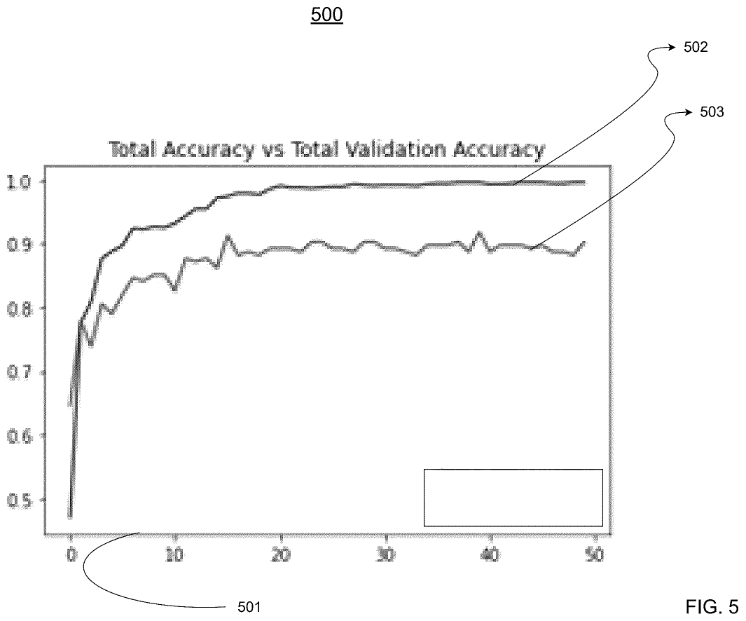

The accuracy function, in some aspects, may comprise a total training accuracy and a total validation accuracy over a given number of training epochs. In the example of FIG. 5, for instance, 50 training epochs were applied, measuring total training accuracy and total validation accuracy.

Skills based examination deployment module 215 includes logic instructions for implementing functionality that includes receiving, at a proctor computing system, a set of timestamped images transmitted from a candidate computing device 102. In some embodiments, the set of timestamped images transmitted from candidate computing device 102 includes images captured by supplementary camera or similar video capture devices that may be deployed to capture the human actions performed during the skills based examination from different vantage points. Thus, it is contemplated that candidate computing device 102 can encompass more than a single image capture device deployed for the purpose of comprehensively capturing the human action actions images during the skills based examination.

The set of timestamped images may encode data regarding durations, including durations for overlapping any ones of the respective human actions as performed by an examination candidate in the skills based examination session.

Skills based examination deployment module 215, in embodiments, comprises logic instructions for implementing functionality that includes generating, in association with the trained AI neural network, a candidate performance profile based at least in part on the set of timestamped images. Then, based on an evaluation of the candidate in accordance with a candidate performance profile, generating an examination performance result for the candidate.

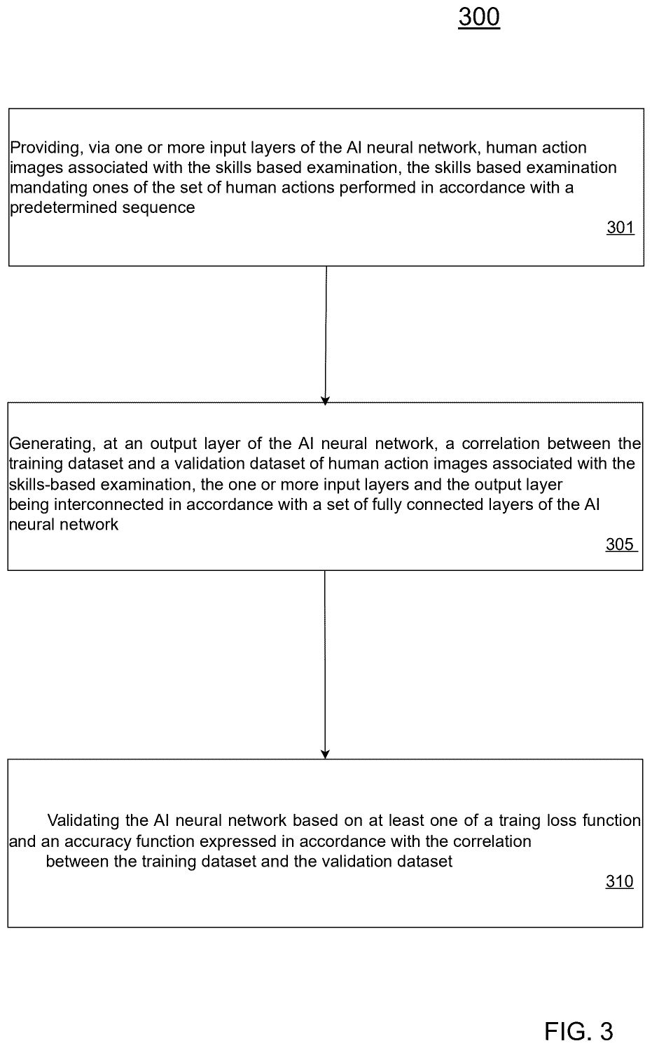

FIG. 3 shows, in an example embodiment, process 300 for training an AI neural network in a skills based examination system. In embodiments, process 300 may be performed by applying any of the devices, systems, and features as described in FIGS. 1-2, used in conjunction with processes of FIG. 3.

At step 301, providing, via one or more input layers of the AI neural network 100, a training dataset of human action images associated with the skills based examination, the skills based examination mandating ones of the set of human actions performed in accordance with a predetermined sequence

At step 305, generating, at an output layer of the AI neural network 100, a correlation between the training dataset and a validation dataset of human action images associated with the skills-based examination, the one or more input layers and the output layer being interconnected in accordance with a set of fully connected layers of the AI neural network.

At step 310, validating the AI neural network based on at least one of a training loss function and an accuracy function expressed in accordance with the correlation between the training dataset and the validation dataset. The training loss function, in some embodiments, may comprise a total training loss and a total validation loss over a given number of training epochs. In embodiments, the accuracy function comprises a total training accuracy and total a validation accuracy over a given number of training epochs.

In some aspects, the skills based examination mandates performance by an examination candidate in accordance with respective ranges of predetermined durations based on the predetermined sequence.

In embodiments, creating the training dataset may be based on pre-processing of a plurality of human action videos. The pre-processing may include extraction of video frames based on one or more of predetermined time intervals and human action motion detections, wherein temporal dynamics of the human action motions constituted in the human action videos may be captured. In some aspects, the AI neural network may be based a fusion of a convolutional neural network (CNN) and a long short term memory (LSTM) neural network. In this arrangement, the CNN performs spatial feature extraction and the LSTM neural network captures temporal dependencies. Such fusion architecture may include sequentially feeding the output of the CNN as input into the LSTM network, thereby enabling the AI neural network to contemporaneously learn spatial and temporal features of the human action motions.

FIG. 4 shows, in an example embodiment, scheme 400 for validating AI neural network 100 based on a training loss function expressed in accordance with a correlation between a training dataset and a validation dataset. In the example of FIG. 4, for instance, 50 training epochs were applied, measuring total training loss and total validation loss.

In an example embodiment, early stopping may be used as a regularization measure to avoid overfitting the training model. Early stopping stops the training when a particular monitored metric shows even a small amount of improvement. Consider that “loss” is the metric to be monitored; if the model reaches a “min mode”, i.e, the minimum level at which loss begins decreasing, a training loop checks whether the loss is truly beginning to decrease, considering a number of epochs 401 the model was trained for. Once this is confirmed, the model training may be terminated. In the particular example depicted in FIG. 4, at 50 epochs, the loss had decreased considerably, and the model was 99.6% accurate in its predictions. Hence, training the model may be terminated after 50 epochs. At this stage, observed total training loss 403 was 0.0355, the accuracy of training model after training was 99.6%, and validation loss 402 was 0.29.

FIG. 5 shows, in an example embodiment, scheme 500 for validating an AI neural network 100 based on an accuracy function expressed in accordance with a correlation between a training dataset and a validation dataset. In the example of FIG. 5, for instance, 50 training epochs 501 were applied, measuring total training accuracy 502 and total validation accuracy 503. As depicted in FIG. 5, the validation accuracy is less than the training accuracy, which shows that the trained AI model is effective, and, subject to drifts and ongoing training updated over time as appropriate, training may be terminated.

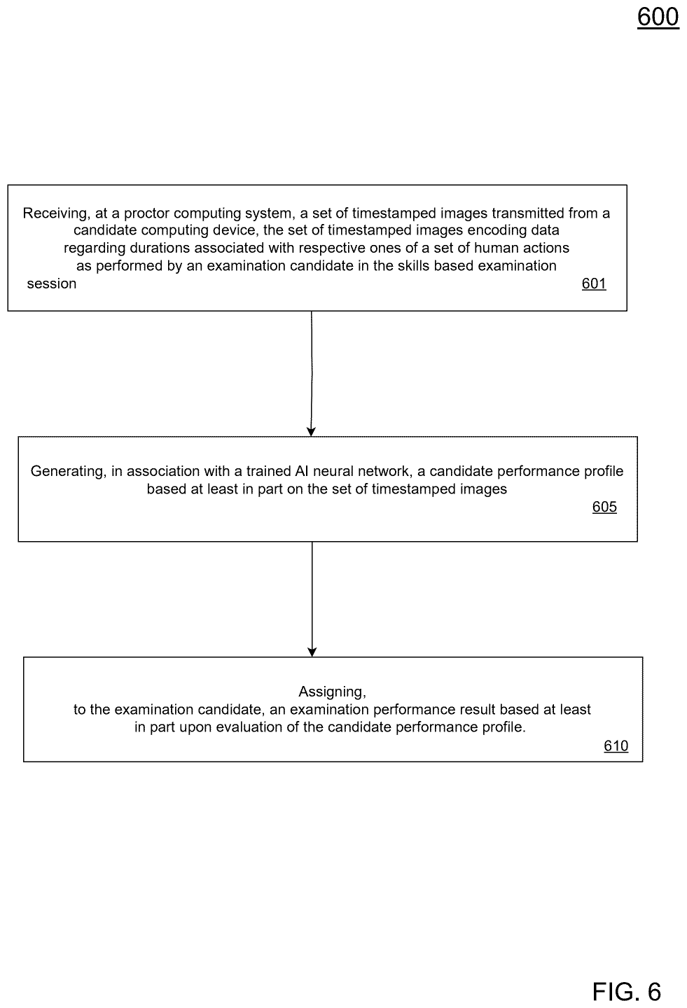

FIG. 6 shows, in an example embodiment, process 600 for deploying an AI neural network in a skills based examination system. In embodiments, process 600 may be performed via any of the devices, systems, and features as described in FIGS. 1-5 used in conjunction with processes of FIG. 6 as described below.

At step 601, receiving, at a proctor computing system, a set of timestamped images transmitted from a candidate computing device, the set of timestamped images encoding data regarding durations associated with respective ones of a set of human actions as performed by an examination candidate in the skills based examination session. In some embodiments, the set of timestamped images transmitted from candidate computing device 102 can also include images captured from different vantage points by supplementary camera or similar video capture devices, including video surveillance camera sources, that may be deployed to capture the human actions as performed in real-time during the skills based examination. Thus, it is contemplated that candidate computing device 102 can encompass more than a single image capture device deployed for the purpose of comprehensively capturing the human action actions images in real-time during the skills based examination.

At step 605, generating, in association with a trained AI neural network, a candidate performance profile based at least in part on the set of timestamped images.

At step 610, assigning, to the examination candidate, an examination performance result based at least in part upon evaluation of the candidate performance profile.

It is contemplated that embodiments described herein be understood to include and encompass varying combinations of elements and concepts recited anywhere in this application. Although embodiments are described in detail herein with reference to the accompanying drawings, it is to be understood that the invention is not limited to only such literal embodiments. For example, it is anticipated that the techniques and systems may be applied or deployed to cases other than any particular examination contexts. Furthermore, it is contemplated that a particular feature described either individually or as part of an embodiment can be combined with other features as described, or parts of other embodiments, even in the absence of a particular described combination. Thus, absence of particular described combinations does not preclude the inventor from claiming rights to such combinations. As such, many modifications and variations will be apparent to practitioners skilled in the art. Accordingly, it is intended that the scope of the invention be defined by the following claims and their equivalents.

What is claimed is:

1. A method of training an artificial intelligence (AI) neural network in validating a set of human actions performed in a skills based examination, the method comprising:
providing, via one or more input layers of the AI neural network, a training dataset of human action images associated with the skills based examination, the skills based examination mandating ones of the set of human actions performed in accordance with a predetermined sequence;
generating, at an output layer of the AI neural network, a correlation between the training dataset and a validation dataset of human action images associated with the skills-based examination, the one or more input layers and the output layer being interconnected in accordance with a set of fully connected layers of the AI neural network; and
validating the AI neural network based on at least one of a training loss function and an accuracy function expressed in accordance with the correlation between the training dataset and the validation dataset.

2. The method of claim 1 wherein the skills based examination mandates performance by an examination candidate in accordance with respective ranges of predetermined durations in accordance with the predetermined sequence.

3. The method of claim 1, further comprising providing the training dataset based on pre-processing of a plurality of human action videos.

4. The method of claim 3 wherein the pre-processing includes extraction of video frames in accordance with at least one of: (i) predetermined time intervals and (ii) human action motion detection, wherein temporal dynamics of the human action motions constituted in the human action videos are captured.

5. The method of claim 3 wherein the AI neural network comprises a fusion of a convolutional neural network (CNN) and a long short term memory (LSTM) neural network.

6. The method of claim 5 wherein the CNN performs spatial feature extraction and the LSTM neural network captures temporal dependencies.

7. The method of claim 5 wherein the fusion comprises sequentially feeding the output of the CNN as input into the LSTM network, enabling the AI neural network to contemporaneously learn spatial and temporal features of the human action motions.

8. The method of claim 1 wherein the training loss function comprises a total training loss and a total validation loss over a given number of training epochs.

9. The method of claim 1 wherein the accuracy function comprises a total training accuracy and total a validation accuracy over a given number of training epochs.

10. The method of claim 1 wherein training the AI neural network produces a trained AI neural network, and further comprising deploying the trained AI neural network in a skills based examination session, the deploying comprising:
receiving, at a proctor computing system, a set of timestamped images transmitted from a candidate computing device, the set of timestamped images encoding data regarding durations associated with respective ones of a set of human actions as performed by an examination candidate in the skills based examination session; and
generating, in association with the trained AI neural network, a candidate performance profile based at least in part on the set of timestamped images.

11. An examination proctor computer system comprising:
one or more processors; and
a memory storing instructions executable in the one or more processors, the instructions encoding a trained artificial intelligence (AI) neural network that is instantiated in the one or more processors, the instructions further causing the one or more processors to implement operations comprising:
receiving, from a candidate computing device that is interconnected with the examination proctor computing system within a distributed network computing system, a set of timestamped images transmitted from the candidate computing device, the set of timestamped images associated with performance of a skills based examination performed by an examination candidate; and
generating, in association with the trained AI neural network, a candidate performance profile based at least in part on the set of timestamped images.

12. The examination proctor computing system of claim 11 further comprising assigning, to the examination candidate, an examination performance result based at least in part upon the candidate performance profile.

13. The examination proctor computing system of claim 11 wherein the trained AI neural network is produced in accordance with a training process comprising:
providing, via one or more input layers of the AI neural network, a training dataset of human action images associated with the skills based examination, the skills based examination mandating ones of the set of human actions performed in accordance with a predetermined sequence;
generating, at an output layer of the AI neural network, a correlation between the training dataset and a validation dataset of human action images associated with the skills-based examination, the one or more input layers and the output layer being interconnected in accordance with a set of fully connected layers of the AI neural network; and
validating the AI neural network based on at least one of a training loss function expressed in accordance with the correlation between the training dataset and the validation dataset.

14. The examination proctor computing system of claim 11 wherein the training dataset is provided based on pre-processing of a plurality of human action videos.

15. The examination proctor computing system of claim 14 wherein the pre-processing includes extraction of video frames in accordance with at least one of: (i) predetermined time intervals and (ii) human action motion detection, wherein temporal dynamics of the human action motions constituted in the human action videos are captured.

16. The examination proctor computing system of claim 11 wherein the AI neural network comprises a fusion of a convolutional neural network (CNN) and a long short term memory (LSTM) neural network.

17. The examination proctor computing system of claim 16 wherein the CNN performs spatial feature extraction and the LSTM neural network captures temporal dependencies.

18. The examination proctor computing system of claim 16 wherein the fusion comprises sequentially feeding the output of the CNN as input into the LSTM network, enabling the AI neural network to contemporaneously learn spatial and temporal features of the human action motions.

19. A computer-readable non-transitory memory having instructions stored thereon, the instructions when executed in one or more processors causing the one or more processors to implement operations comprising:
receiving, from a candidate computing device that is interconnected with an examination proctor computing system within a distributed network computing system, a set of timestamped images transmitted from the candidate computing device, the set of timestamped images associated with performance of a skills based examination performed by an examination candidate; and
generating, in association with a trained artificial intelligence (AI) neural network, a candidate performance profile based at least in part on the set of timestamped images.

20. The computer-readable non-transitory memory of claim 19 wherein the instructions when executed in one or more processors further causing the one or more processors to implement operations comprising assigning, to the examination candidate, an examination performance result based at least in part upon the candidate performance profile.
